(19) United States
(12) Patent Application Publication
(10) Pub. No.: US 2013/0268569 A1
(43) Pub. Date: Oct. 10, 2013

(54) SELECTING A TILE SIZE FOR THE COMPRESSION OF DEPTH AND/OR COLOR DATA

(71) Applicants: Tomas G. Akenine-Moller, Lund (SE); Magnus Andersson, Helsingborg (SE); Jon N. Hasselgren, Bunkeflostrand (SE); Jim K. Nilsson, Lund (SE)

(72) Inventors: Tomas G. Akenine-Moller, Lund (SE); Magnus Andersson, Helsingborg (SE); Jon N. Hasselgren, Bunkeflostrand (SE); Jim K. Nilsson, Lund (SE)

(21) Appl. No.: 13/853,091

(22) Filed: Mar. 29, 2013

Related U.S. Application Data
(60) Provisional application No. 61/620,045, filed on Apr. 4, 2012.

(51) Int. Cl. G06F 17/30

(52) U.S. Cl. CPC G06F 17/30312
USPC 707/825

(57) ABSTRACT

In accordance with some embodiments, depth and/or color data may be compressed by selecting one of at least two different tile sizes based on considerations of storage requirements and average number of samples per tile.

### CROSS-REFERENCE TO RELATED APPLICATION

This application is a non-provisional application claiming priority to provisional application 61/620,045 filed Apr. 4, 2012, which is hereby expressly incorporated by reference herein.

### BACKGROUND

This relates to graphics processing.

Color data and depth data can be stored when a pixel is rendered. Depth data may be used to cull objects that would be hidden to avoid processing them. Depth testing determines which of two overlapping pixels is closer to the camera. The depth function determines what to do with the test result.

A depth buffer may store per-pixel floating-point or integer depth data for each pixel rendered. A depth buffer may also contain stencil data which can be used to do more complex rendering such as simple shadows or outlines, or alternatively, a stencil can be stored separately.

Reducing memory bandwidth usage in graphics processors is becoming increasingly important, both from a performance perspective and from a power efficiency perspective. The data traffic to and from the depth buffer consume a significant amount of bandwidth, and it is therefore important to reduce this traffic as much as possible. Common approaches include Zmax-culling, Zmin-culling, depth caching, and depth compression. For color data, color caching and color compression are common methods.

### BRIEF DESCRIPTION OF THE DRAWINGS

Some embodiments are described with respect to the following figures:

FIG. 1 is a schematic depiction of one embodiment;

FIG. 2 is a flow chart for one embodiment;

FIG. 3 is a pictorial description of one embodiment;

FIG. 4 is a system depiction for one embodiment; and

FIG. 5 is a front elevational view of one embodiment.

### DETAILED DESCRIPTION

In accordance with some embodiments, depth and/or color data may be compressed by selecting one of at least two different tile sizes based on considerations of storage requirements and average number of samples per tile.

For depth and color data, the cache line sizes are often much larger than the size of a single sample. Samples are therefore often grouped together into screen space regions called tiles which naturally fit in to one, or an integral number of cache lines. For example, if the cache line size is 512 bits and the precision of each individual depth sample is 32 bits, then the depth buffer may be partitioned into tiles of 4×4 depth samples each.

To reduce bandwidth usage, and to be able to fit more data into the caches, data compression is often employed at different points in the memory hierarchy. However, the compressed data is designed to fit into an integral number of cache lines. Thus, compression is only possible if the selected tile size spans more than one cache line. For example, selecting a tile size of 8×8 depth samples (instead of the convention 4×4 depth samples), would require 2,048 bits (=8*8*32, assuming 32 bits per depth) and thus occupy four cache lines. If the data could be compressed down to 512 bits, only one cache line would be required in the level 2 (L2) memory. In some embodiments, the compressed data is stored in the level 2 memory while the uncompressed data is stored in a level 1 (L1) memory. By compressing the data to the greatest possible extent, less data is transferred over the memory bus, resulting in reduced memory bandwidth usage which may improve performance.

One problem with existing techniques is overeviction (i.e. overdeletion) of data that is no longer being used. If the attempted compression fails, the tile would have to remain in an uncompressed format. Current graphics application program interfaces (APIs) require that both color and depth data remain in a non-lossy format. Therefore, when an API requires color and depth data remain in non-lossy format, and compression produces a lossy format, there will be one mode that is uncompressed. If the tile size increases from 4×4 to 8×8, a compression failure results in a larger screen space region being evicted (than if 4×4 tiles were used). Thus, to avoid overeviction, one may prefer smaller tile sizes, compared to larger tile sizes.

Another potentially harmful effect of having larger tiles sizes may be called overfetching. It may occur when a tile (either compressed or uncompressed) is read back from the level 2 to the level 1 cache. For example, the tile could be previously compressed down to 512 bits using 4:1 compression but before it reaches a level 1 cache it would have to be decompressed and thus expanded to occupy four cache lines. A larger region of sample data, for example 8×8, may be more than what is needed for this operation. Hence, larger tile sizes may lead to some overfetching. Obviously, this is non-optimal for tile sizes larger than one cache line. On average, it is desirable that the compression is good enough to counter the overfetching effects and failed compression attempts that arise when using larger tile sizes.

Thus, it is advantageous to have the ability to consider more than one tile size in a depth system and/or in a color system in a graphics processor or graphics processing system. This generally means a system may need more than one compressor/decompressor, or at least variations of the same compression/decompression algorithm supporting different compression ratios. Whether to use one or the other of the tile sizes may involve considerations of overfetching, overeviction, and overstorage. Thus, by trading off these considerations, one can improve the efficiency of the system.

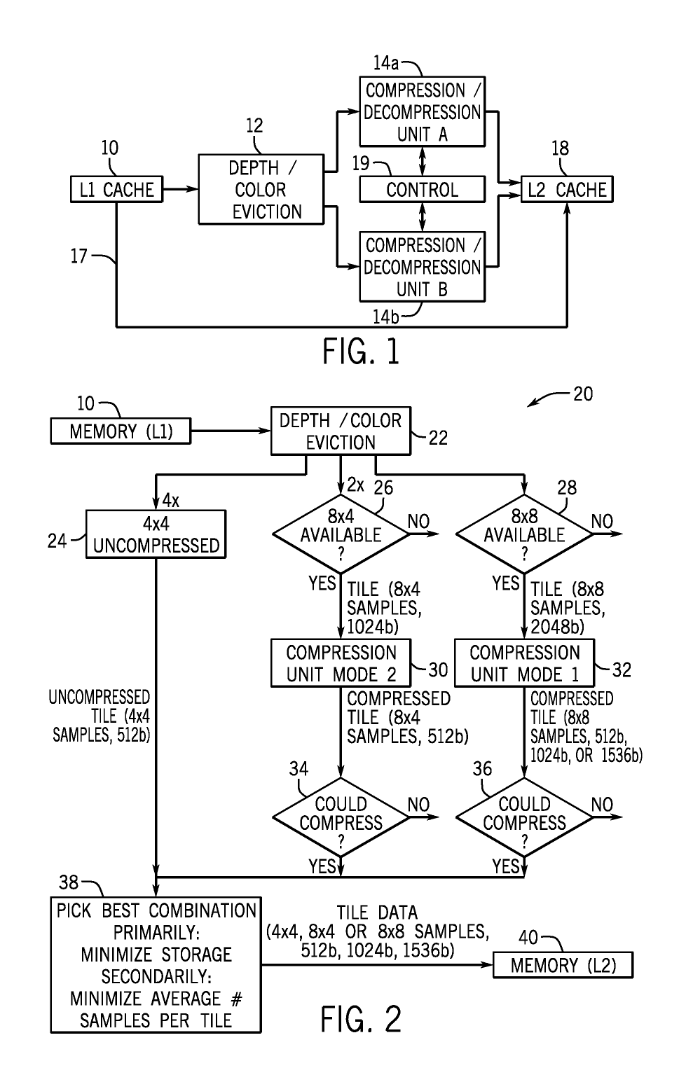

Thus in accordance with some embodiments, a system is provided in which at least two compressors/decompressors are available as shown in FIG. 1. Memory, in the form of a level 1 (L1) cache 10, evicts a depth/color tile 12 which is then sent to one of at least two compression/decompression units 14a and 14b. A check in association with each compression unit determines whether or not the compression is possible and if so, the data may be compressed using a selected tile size and stored in a level 2 (L2) memory 18.

Bandwidth between caches 10 and 18 may be reduced by keeping the average number of samples in a tile to a minimum, since overfetching effects can be reduced. For any sample requested that is not in a level 1 memory, a minimum number of additional samples are advantageously fetched from level 2 memory, decompressed (using a decompression capability of a unit 14a and 14b) and inserted into level 1 memory, occupying as few cache lines as possible.

While FIG. 1 shows an example with two different tile sizes and two compression units, any number of compression units and tile sizes may be used. In some embodiments a post-cache coder/decoder or compressor/decompressor is used, which means that data is decompressed and stored in an uncompressed form in the level 1 cache shown in FIG. 1. Uncompressed data can be passed between caches 10 and 18 via line 17. A control 19 may determine how to trade off reducing storage versus reducing an average number of samples per tile by picking a tile size for compression.

Referring next to FIG. 2, a sequence is shown for implementing selectable tile sizes in accordance with some embodiments. The sequence may be implemented in software, firmware and/or hardware. In software and firmware embodiments, it may be implemented by computer executed instructions stored in one or more non-transitory computer readable media such as magnetic, optical or semiconductor storages.

The sequence begins with a cache eviction request of a tile containing depth or color data, as indicated in block 22. The color and depth data is evicted from the level 1 memory 10. In this example, different tile sizes may be chosen. A 4×4 size may be uncompressed in one embodiment, as indicated in block 24. In this case, an uncompressed tile containing 512 bits and 4×4 samples may be provided to a selection unit 38.

The 4×4 tile is part of a larger region comprised of a supertile of N×M neighboring tiles. In the example in FIG. 2 the supertile size is 8×8 samples (i.e. 2×2 tiles of size 4×4 samples), which in this particular example is the largest tile size supported by any compressor. Each compressor depicted in FIG. 1 receives as much data as is available within the supertile. In FIG. 2, compressors working on 8×4 and 8×8 samples are available, as well as a path for uncompressed 4×4 tiles. Path 24 will then receive four 4×4 tiles, path 26 will receive two 8×4 tiles and path 28 will receive the full supertile of size 8×8 samples. The control 19 makes the decision of block 38 of FIG. 2 in one embodiment.

Returning to the center path, a check at diamond 26 determines whether a 8×4 tile of samples is available in cache memory 10. If so, the tile is compressed in a compression unit 30 dedicated to the 8×4 tile size. The compressed tile is then forwarded to a check at diamond 34 that determines whether the compression was possible. If not the flow ends. If so, the yes indication goes to the decision block 38.

Referring next to the right path in FIG. 2, diamond 28 determines whether an 8×8 tile is available in cache memory 10. If so, it is compressed by a compression unit 32 dedicated to 8×8 samples. Then a check at diamond 36 determines whether the compression was successful. If so, this tile size goes to the decision unit 38. The tile data is ultimately stored in level 2 memory 40.

The decision unit 38 (implemented by control 19 in FIG. 1) picks the best combination of subtiles from block 24, compression unit 30, and compression unit 32, with potentially mixed sizes. The best combination can be selected based on considerations of minimizing storage and secondarily minimizing the average number of samples per subtile, effectively lowering overfetching. If multiple tile combinations fulfill that criterion, the combination with the highest amount of tiles is selected.

One embodiment then evicts the best subtile overlapping the 4×4 tile. The best subtile is selected based on a heuristic taking compression ratio and number of samples in the tile into account. In another embodiment, the system may choose to evict the entire region in which compression was attempted: that is, the entire supertile.

In this particular variant, there are enough parallel compression paths to cover the entire 8×8 tile (i.e. two 8×4 and four 4×4 tiles). Therefore, the 8×4 path is replicated two times to handle two such tiles (hence the 2x in FIG. 2). Similarly, the 4×4 path is replicated four times to cover the 8×8 tile.

In a third embodiment, only one compression unit is used per compression format available (i.e. no replication of compression units). This variant only attempts compression on the subtiles overlapping the 4×4 tile to be evicted, whereas the previous embodiments worked on the entire supertile. In other words, as before, compression is attempted on one 8×8 tile, but for the 8×4 compression unit, only one 8×4 tile is attempted, instead of two. Thus, the heuristic based on storage and sample count is not applied on the larger supertile region (for example 8×8 samples), but instead only locally on the subtiles (4×4, 8×4 and 8×8) that contain the evicted 4×4 tile.

While examples are given above, the contemplated embodiments are not bound to the example tile sizes and configurations. The concepts described herein can be used for any tile size and any combinations thereof. While a system or compression is performed in parallel as described, compression could also be implemented serially or each new compression attempt is performed only if the previous compression ratio was not good enough. For such an embodiment, intermediary computations can be reused in the subsequent compression attempts. While 8×8, 8×4 and 4×4 tiles are used in the embodiments described herein, any size tiles may be used including 16×8, 16×16 for larger examples, and 4×2 and 2×2 for smaller sized examples.

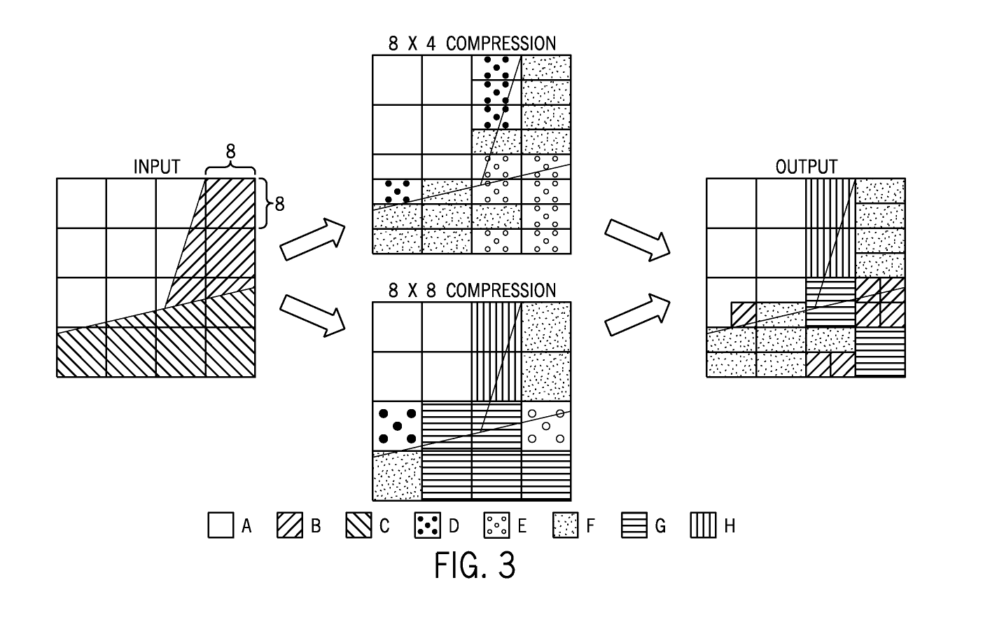

Referring to FIG. 3, an example of two triangles (depicted in the block under “Input” and shaded as indicated at B and C) is given solely for illustration purposes. The two triangles are contained in a large screen space region that is present in the L1 cache. Each cache line is occupied by a 4×4 tile (the smallest depicted tile size in FIG. 3) in uncompressed format. As shown in the middle depictions, for each 4×4 eviction request, two 8×4 (under “8×4 compression”) and one 8×8 tile (under “8×8 compression”) are gathered and sent to the compression units 14 (FIGS. 1) or 30 and 32 (FIG. 2). Tiles that cannot gain anything from the compression (over the uncompressed representation) are skipped (indicated by shading D). The middle depictions show which tiles fail (shading E) and which tiles are skipped because nothing was gained by compressing the tile. The right depiction, labeled “result” shows the resulting raw tiles (shading B), cleared tiles (shading A), tiles that were able to be compressed 4:1 (shading H), tiles that were able to be compressed 2:1 (shading F) and tiles that were able to be compressed 4:3 (shading G).

Thus the 8×8 tiles and the 8×4 tiles that were skipped (shading D) were skipped because they did not cover sufficient triangle area to be of any value. The tiles with shading E were ones that could not be compressed.

In the right depiction labeled “output”, the tiles that failed were simply maintained as raw or uncompressed tiles (shading E). In the middle depictions, the lower right corner includes tiles that were compressed 4:3 in the 8×8 tile compression unit but failed (shading E) in the 8×4 compression unit. So in the “output” depiction, the 8×8 tile compression (shading G) was chosen. Likewise a tile at the intersection of the two triangles failed in the 8×4 tile compression unit but was successful (4:3 compression) in the 8×8 tile compression unit and therefore was compressed using 8×8 tile compression 4:3 in the output.

The decision about what tile size is best may be done at 38 in FIG. 2 and by the control 19 (FIG. 1) in one embodiment. The idea is to reduce bandwidth and also reduce the average number of samples. If not enough compression can be obtained, it may not be worth compressing. If possible, it is generally preferable to use a smaller tile size. Note in the example of FIG. 2, where compression was possible in the 8×4 size, the 8×4 was always the selected size even though the smaller tile size achieved 2:1 compression. Thus where tiles of different size were compressible to the same degree, both in 8×4 and 8×8 sizes, the 8×4 sizes may be chosen to reduce storage by using the finest compressed granularity. In general, if multiple tile sizes achieve the best possible compression, the smallest size is chosen in one embodiment.

Thus for the example given in FIG. 3, if 4×4 tiles were used without compression, the relative storage (ratio of 4×4 storage requirement to 4×4 storage requirement) of 4×4 raw is the same as 4×4 (i.e., 1) and the average number of samples per tile is 16. If only 8×4 compression is possible, then the relative storage, compared to the 4×4 raw, is 0.75 and the average number of samples per tile is 22.1. If 8×8 only compression is used, then the relative storage is 0.7 and the average number of samples per tile is 40. However using selected 8×4 and 8×8 sizes combined, as described herein, the relative storage is 0.63 and the number of samples per tile is 30.5. So the combined size compression enjoys lower storage requirements than other possibilities, while being able to reduce potential overfetching resulting from using only an 8×8 tile compression unit in some embodiments.

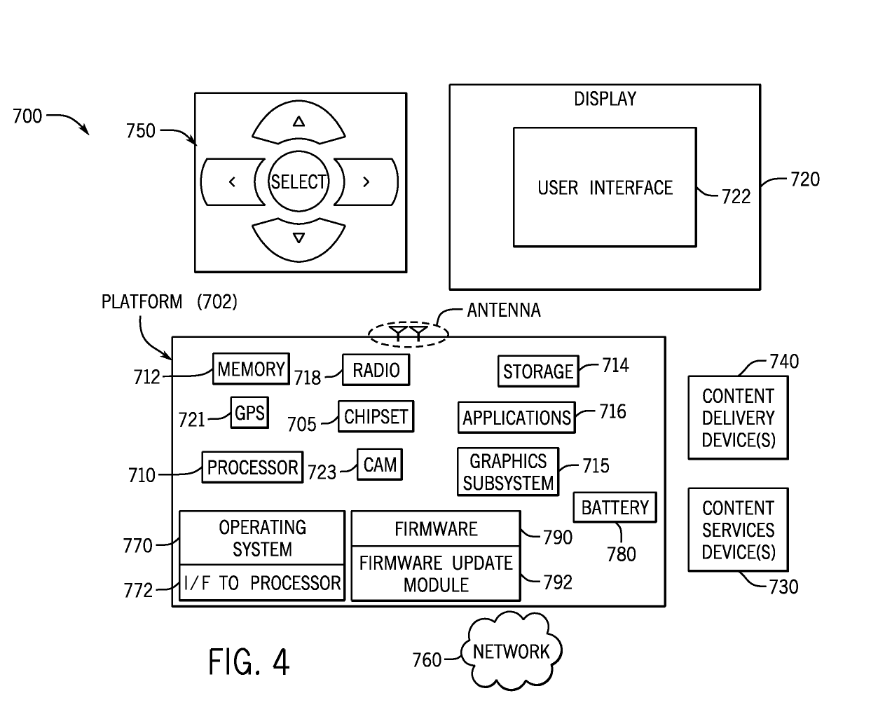

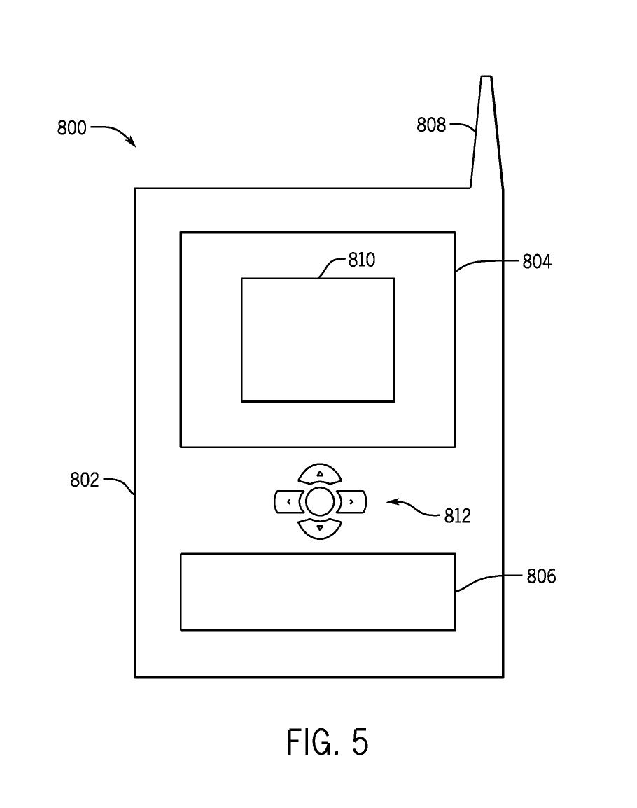

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 2 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705.

Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the scope of this disclosure.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the scope of this disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

As described above, system 700 may be embodied in varying physical styles or form factors. FIG. 4 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 2 in software and/or firmware embodiments.

As shown in FIG. 4, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The following clauses and/or examples pertain to further embodiments:

One example embodiment may be a method comprising in a tiled storage system in a graphics processor, selecting a tile size dynamically based on current data content. The method may also include using at least two compressed tile sizes and one uncompressed tile size. The method may also include selecting a tile size based on storage requirements and average number of samples per tile. The method may also include determining whether a set of tile sizes can be compressed and selecting a tile size based to reduce memory bandwidth. The method may also include using a heuristic to minimize tile storage, and minimizing the number of samples in a tile. The method may also include selecting between at least one uncompressed tile size and any number of compressed tile sizes. The method may also include selecting based at least in part on the average number of samples per tile. The method may also include determining whether one of a depth or color tile can be compressed. The method may also include receiving uncompressed tiles from a level 1 cache. The method may also include storing the selected tile in a level 2 cache.

In another example embodiment may be one or more non-transitory computer readable media storing instructions executed by a graphics processor to perform a sequence comprising in a tiled storage system selecting a tile size dynamically based on current data content. The media may store said sequence including using at least two compressed tile sizes and one uncompressed tile size. The media may store said sequence including selecting a tile size based on storage requirements and average number of samples per tile. The media may store said sequence including determining whether a set of tile sizes can be compressed and selecting a tile size based to reduce memory bandwidth. The media may store said sequence including using a heuristic to minimize tile storage, and minimizing the number of samples in a tile. The media may store said sequence including selecting between at least one uncompressed tile size and any number of compressed tile sizes. The media may store said sequence including selecting based at least in part on the average number of samples per tile. The media may store said sequence including determining whether one of a depth or color tile can be compressed. The media may store said sequence including receiving uncompressed tiles from a level 1 cache. The media may store said sequence including storing the selected tile in a level 2 cache.

Another example embodiment may be an apparatus comprising a tiled storage system and a graphics processor, coupled to said system, to select a tile size dynamically based on current data content. The apparatus may include said processor to use at least two compressed tile sizes and one uncompressed tile size. The apparatus may include said processor to select a tile size based on storage requirements and average number of samples per tile. The apparatus may include said processor to determine whether a set of tile sizes can be compressed and selecting a tile size based to reduce memory bandwidth. The apparatus may include said processor to use a heuristic to minimize tile storage, and minimizing the number of samples in a tile. The apparatus may include said processor to select between at least one uncompressed tile size and any number of compressed tile sizes. The apparatus may include said processor to select based at least in part on the average number of samples per tile. The apparatus may include an operating system. The apparatus may include a battery. The apparatus may include firmware and a module to update said firmware.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
in a tiled storage system in a graphics processor, selecting a tile size dynamically based on current data content.

2. The method of claim 1 including using at least two compressed tile sizes and one uncompressed tile size.

3. The method of claim 1 including selecting a tile size based on storage requirements and average number of samples per tile.

4. A method of claim 1 including determining whether a set of tile sizes can be compressed and selecting a tile size based to reduce memory bandwidth.

5. The method of claim 4 including using a heuristic to minimize tile storage, and minimizing the number of samples in a tile.

6. The method of claim 4 including selecting between at least one uncompressed tile size and any number of compressed tile sizes.

7. The method of claim 6 including selecting based at least in part on the average number of samples per tile.

8. The method of claim 4 including determining whether one of a depth or color tile can be compressed.

9. The method of claim 4 including receiving uncompressed tiles from a level 1 cache.

10. The method of claim 9 including storing the selected tile in a level 2 cache.

11. One or more non-transitory computer readable media storing instructions executed by a graphics processor to perform a sequence comprising:
in a tiled storage system selecting a tile size dynamically based on current data content.

12. The media of claim 11, said sequence including using at least two compressed tile sizes and one uncompressed tile size.

13. The media of claim 11, said sequence including selecting a tile size based on storage requirements and average number of samples per tile.

14. A media of claim 11, said sequence including determining whether a set of tile sizes can be compressed and selecting a tile size based to reduce memory bandwidth.

15. The media of claim 14, said sequence including using a heuristic to minimize tile storage, and minimizing the number of samples in a tile.

16. The media of claim 14, said sequence including selecting between at least one uncompressed tile size and any number of compressed tile sizes.

17. The media of claim 16, said sequence including selecting based at least in part on the average number of samples per tile.

18. The media of claim 14, said sequence including determining whether one of a depth or color tile can be compressed.

19. The media of claim 14, said sequence including receiving uncompressed tiles from a level 1 cache.

20. The media of claim 19, said sequence including storing the selected tile in a level 2 cache.

21. An apparatus comprising:
a tiled storage system; and
a graphics processor, coupled to said system, to select a tile size dynamically based on current data content.

22. The apparatus of claim 21, said processor to use at least two compressed tile sizes and one uncompressed tile size.

23. The apparatus of claim 21, said processor to select a tile size based on storage requirements and average number of samples per tile.

24. A apparatus of claim 21, said processor to determine whether a set of tile sizes can be compressed and selecting a tile size based to reduce memory bandwidth.

25. The apparatus of claim 24, said processor to use a heuristic to minimize tile storage, and minimizing the number of samples in a tile.

26. The apparatus of claim 24, said processor to select between at least one uncompressed tile size and any number of compressed tile sizes.

27. The apparatus of claim 26, said processor to select based at least in part on the average number of samples per tile.

28. The apparatus of claim 21 including an operating system.

29. The apparatus of claim 21 including a battery.

30. The apparatus of claim 21 including firmware and a module to update said firmware.
